(19) United States
(12) Patent Application Publication
(10) Pub. No.: US 2019/0077130 A1
(43) Pub. Date: Mar. 14, 2019

(54) PLASTIC PRODUCT WHICH INCLUDES SYNTHETIC POLYMER FILM WHOSE SURFACE HAS MICROBICIDAL ACTIVITY

(71) Applicant: SHARP KABUSHIKI KAISHA, Osaka (JP)

(72) Inventors: YASUHIRO SHIBAI, Sakai City (JP); MIHO YAMADA, Sakai City (JP); KEN ATSUMO, Sakai City (JP); KIYOSHI MINOURA, Sakai City (JP)

(21) Appl. No.: 16/131,688

(22) Filed: Sep. 14, 2018

(30) Foreign Application Priority Data
Sep. 14, 2017 (JP) 2017-176590

(51) Int. Cl. B32B 27/08; B32B 27/36; B32B 27/30; B32B 3/30; B32B 27/28; C08L 71/02; C08L 69/00; C08L 33/10

(52) U.S. Cl. CPC B32B 27/08; B32B 27/365; B32B 27/308; B32B 3/30; B82Y 30/00; C08L 71/02; C08L 69/00; C08L 33/10; C08L 2203/16; B32B 27/285

(57) ABSTRACT

A plastic product includes a plastic base which has a surface and a synthetic polymer film provided on the surface of the plastic base, the surface of the plastic base being made of polycarbonate. The synthetic polymer film has raised portions whose two-dimensional size is in a range of more than 20 nm and less than 500 nm when viewed in its normal direction. A crosslink structure of the synthetic polymer film contains an ethylene oxide unit and a 2-(2-vinyloxy ethoxy)ethyl (meth)acrylate monomer unit. The proportion of the contained ethylene oxide unit to the entirety of the synthetic polymer film is not less than 35 mass % and less than 70 mass %. The proportion of the contained 2-(2-vinyloxy ethoxy)ethyl (meth)acrylate monomer unit to the entirety of the synthetic polymer film is not less than 15 mass % and less than 45 mass %.

### BACKGROUND

### 1. Technical Field

The present invention relates to a plastic product which includes a synthetic polymer film whose surface has a microbicidal activity.

### 2. Description of the Related Art

Recently, it was reported that surficial nanostructures of black silicon, wings of cicadas and dragonflies have a bactericidal activity (Ivanova, E. P. et al., “Bactericidal activity of black silicon”, Nat. Commun. 4:2838 doi: 10.1038/ncomms3838 (2013)). Reportedly, the physical structure of the nanopillars that black silicon and wings of cicadas and dragonflies have produces a bactericidal activity.

According to Ivanova, E. P. et al., black silicon has the strongest bactericidal activity on Gram-negative bacteria, while wings of dragonflies have a weaker bactericidal activity, and wings of cicadas have a still weaker bactericidal activity. Black silicon has 500 nm tall nanopillars. Wings of cicadas and dragonflies have 240 nm tall nanopillars. The static contact angle (hereinafter, sometimes simply referred to as “contact angle”) of the black silicon surface with respect to water is 80°, while the contact angles of the surface of wings of dragonflies and cicadas with respect to water are 153° and 159°, respectively. It is estimated that black silicon is mainly made of silicon, and wings of dragonflies and cicadas are made of chitin. According to Ivanova, E. P. et al., the composition of the surface of black silicon is generally a silicon oxide, and the composition of the surface of wings of dragonflies and cicadas is generally a lipid.

### SUMMARY

The mechanism of killing bacteria by nanopillars is not clear from the results described in Ivanova, E. P. et al. It is also not clear whether the reason why black silicon has a stronger bactericidal activity than wings of dragonflies and cicadas resides in the difference in height or shape of nanopillars, in the difference in surface free energy (which can be evaluated by the contact angle), in the materials that constitute nanopillars, or in the chemical properties of the surface.

The bactericidal activity of black silicon is difficult to utilize because black silicon is poor in mass productivity and is hard but brittle so that the shapability is poor.

In view of the above-described circumstances, the present applicant developed a synthetic polymer film whose surface has a microbicidal activity and a sterilization method with the use of the surface of the synthetic polymer film as will be described later (for example, WO 2015/163018 (Japanese Patent No. 5788128), WO 2016/080245 (Japanese Patent No. 5933151), and WO 2016/208540). However, according to research carried out by the present inventors, it was found that the synthetic polymer films disclosed in WO 2015/163018, WO 2016/080245 and WO 2016/208540 have sufficient adhesion to PET (polyethylene terephthalate) and TAC (triacetyl cellulose) but insufficient adhesion to PC (polycarbonate).

The present invention was conceived for the purpose of solving the above problems. The major objects of the present invention include improving the adhesion to PC of a synthetic polymer film whose surface has a microbicidal activity and providing a plastic product which includes a synthetic polymer film whose surface has a microbicidal activity over a surface of a plastic base which is made of polycarbonate.

A plastic product according to an embodiment of the present invention is a plastic product including a plastic base which has a surface and a synthetic polymer film provided on the surface of the plastic base, the surface of the plastic base being made of polycarbonate, wherein the synthetic polymer film has a plurality of first raised portions whose two-dimensional size is in a range of more than 20 nm and less than 500 nm when viewed in a normal direction of the synthetic polymer film, the synthetic polymer film has a crosslink structure, the crosslink structure containing an ethylene oxide unit and a 2-(2-vinyloxy ethoxy)ethyl (meth)acrylate monomer unit, and a proportion of the contained ethylene oxide unit to an entirety of the synthetic polymer film is not less than 35 mass % and less than 70 mass %, and a proportion of the contained 2-(2-vinyloxy ethoxy)ethyl (meth)acrylate monomer unit to the entirety of the synthetic polymer film is not less than 15 mass % and less than 45 mass %.

In one embodiment, the proportion of the contained 2-(2-vinyloxy ethoxy)ethyl (meth)acrylate monomer unit is less than 40 mass %.

In one embodiment, the proportion of the contained ethylene oxide unit is less than 60 mass %.

In one embodiment, the proportion of the contained ethylene oxide unit is less than 50 mass %.

In one embodiment, the proportion of the contained ethylene oxide unit is more than 40 mass %.

In one embodiment, the crosslink structure does not contain a nitrogen element which is a constituent of a urethane bond or a fluorine element.

In one embodiment, the plastic base includes a polycarbonate film.

In one embodiment, the plastic product is a layered film which includes the polycarbonate film and the synthetic polymer film.

According to an embodiment of the present invention, a plastic product is provided which includes a synthetic polymer film whose surface has a microbicidal activity over a surface of a plastic base which is made of polycarbonate.

### BRIEF DESCRIPTION OF THE DRAWINGS

FIG. 1A and FIG. 1B are schematic cross-sectional views of synthetic polymer films 34A and 34B, respectively, according to embodiments of the present invention.

FIG. 2A, FIG. 2B, FIG. 2C, FIG. 2D, and FIG. 2E are diagrams for illustrating a method for manufacturing a moth-eye mold 100A and a configuration of the moth-eye mold 100A.

FIG. 3A, FIG. 3B, and FIG. 3C are diagrams for illustrating a method for manufacturing a moth-eye mold 100B and a configuration of the moth-eye mold 100B.

FIG. 4A shows a SEM image of a surface of an aluminum base. FIG. 4B shows a SEM image of a surface of an aluminum film. FIG. 4C shows a SEM image of a cross section of the aluminum film.

FIG. 5A is a schematic plan view of a porous alumina layer of a mold. FIG. 5B is a schematic cross-sectional view of the porous alumina layer. FIG. 5C is a SEM image of a prototype mold.

FIG. 6 is a diagram for illustrating a method for producing a synthetic polymer film with the use of the moth-eye mold 100.

FIG. 7A and FIG. 7B show SEM images obtained by SEM (Scanning Electron Microscope) observation of a P. aeruginosa bacterium which died at a surface which had a moth-eye structure.

### DETAILED DESCRIPTION

Hereinafter, a synthetic polymer film whose surface has a microbicidal effect and a sterilization method with the use of the surface of the synthetic polymer film according to embodiments of the present invention are described with reference to the drawings.

In this specification, the following terms are used.

“Sterilization” (or “microbicidal”) means reducing the number of proliferative microorganisms contained in an object, such as solid or liquid, or a limited space, by an effective number.

“Microorganism” includes viruses, bacteria, and fungi.

“Antimicrobial” generally includes suppressing and preventing multiplication of microorganisms and includes suppressing dinginess and slime which are attributed to microorganisms.

The present applicant conceived a method for producing an antireflection film (an antireflection surface) which has a moth-eye structure with the use of an anodized porous alumina layer. Using the anodized porous alumina layer enables manufacture of a mold which has an inverted moth-eye structure with high mass-productivity.

The present inventors developed the above-described technology and arrived at a synthetic polymer film whose surface has a microbicidal effect (see, for example, WO 2015/163018, WO 2016/080245 and WO 2016/208540). The entire disclosures of WO 2015/163018, WO 2016/080245 and WO 2016/208540 are incorporated by reference in this specification.

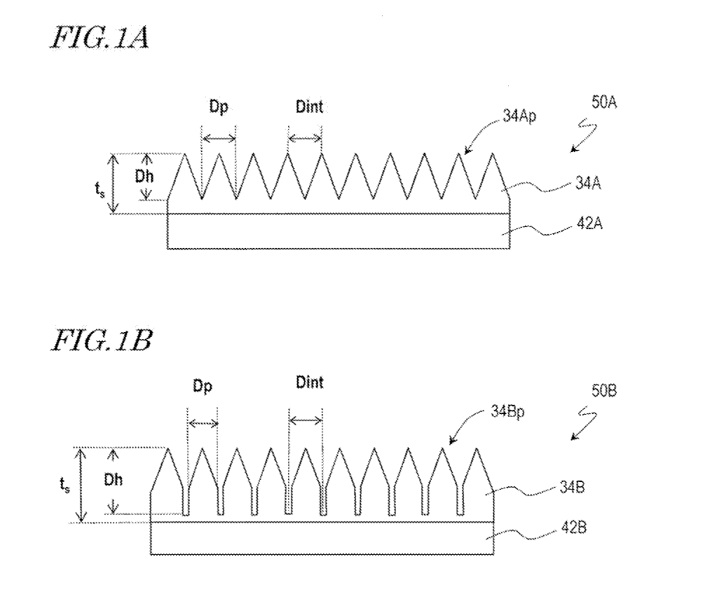

The configuration of a synthetic polymer film according to an embodiment of the present invention is described with reference to FIG. 1A and FIG. 1B.

FIG. 1A and FIG. 1B respectively show schematic cross-sectional views of synthetic polymer films 34A and 34B according to embodiments of the present invention. The synthetic polymer films 34A and 34B described herein as examples are formed on base films 42A and 42B, respectively, although the present invention is not limited to these examples. The synthetic polymer films 34A and 34B can be directly formed on a surface of an arbitrary object.

A film 50A shown in FIG. 1A includes a base film 42A and a synthetic polymer film 34A provided on the base film 42A. The synthetic polymer film 34A has a plurality of raised portions 34Ap over its surface. The plurality of raised portions 34Ap constitute a moth-eye structure. When viewed in a normal direction of the synthetic polymer film 34A, the two-dimensional size of the raised portions 34Ap, Dₚ, is in the range of more than 20 nm and less than 500 nm. Here, the “two-dimensional size” of the raised portions 34Ap refers to the diameter of a circle equivalent to the area of the raised portions 34Ap when viewed in a normal direction of the surface. When the raised portions 34Ap have a conical shape, for example, the two-dimensional size of the raised portions 34Ap is equivalent to the diameter of the base of the cone. The typical adjoining distance of the raised portions 34Ap, Dᵢₙₜ, is more than 20 nm and not more than 1000 nm. When the raised portions 34Ap are densely arranged so that there is no gap between adjoining raised portions 34Ap (e.g., the bases of the cones partially overlap each other) as shown in FIG. 1A, the two-dimensional size of the raised portions 34Ap, Dₚ, is equal, to the adjoining distance Dᵢₙₜ. The typical height of the raised portions 34Ap, Dₕ, is not less than 50 nm and less than 500 nm. As will be described later, a microbicidal activity is exhibited even when the height Dₕ of the raised portions 34Ap is not more than 150 nm. The thickness of the synthetic polymer film 34A, tₛ, is not particularly limited but only needs to be greater than the height Dₕ, of the raised portions 34Ap.

The synthetic polymer film 34A shown in FIG. 1A has the same moth-eye structure as the antireflection films disclosed in Japanese Patent No. 4265729, Japanese Laid-Open Patent Publication No. 2009-166502, WO 2011/125486 and WO 2013/183576. From the viewpoint of producing an antireflection function, it is preferred that the surface has no flat portion, and the raised portions 34Ap are densely arranged over the surface. Further, the raised portions 34Ap preferably has a such shape that the cross-sectional area (a cross section parallel to a plane which is orthogonal to an incoming light ray, e.g., a cross section parallel to the surface of the base film 42A) increases from the air side to the base film 42A side, e.g., a conical shape. From the viewpoint of suppressing interference of light, it is preferred that the raised portions 34Ap are arranged without regularity, preferably randomly. However, these features are unnecessary when only the microbicidal activity of the synthetic polymer film 34A is pursued. For example, the raised portions 34Ap do not need to be densely arranged. The raised portions 34Ap may be regularly arranged. Note that, however, the shape and arrangement of the raised portions 34Ap are preferably selected such that the raised portions 34Ap effectively act on microorganisms.

A film 50B shown in FIG. 1B includes a base film 42B and a synthetic polymer film 34B provided on the base film 42B. The synthetic polymer film 34B has a plurality of raised portions 34Bp over its surface. The plurality of raised portions 34Bp constitute a moth-eye structure. In the film 50B, the configuration of the raised portions 34Bp of the synthetic polymer film 34B is different from that of the raised portions 34Ap of the synthetic polymer film 34A of the film 50A. Descriptions of features which are common with those of the film 50A are sometimes omitted.

When viewed in a normal direction of the synthetic polymer film 34B, the two-dimensional size of the raised portions 34Bp, Dₚ, is in the range of more than 20 nm and less than 500 nm. The typical adjoining distance of the raised portions 34Bp, Dᵢₙₜ, is more than 20 nm and not more than 1000 nm, and Dₚ<Dᵢₙₜ holds. That is, in the synthetic polymer film 34B, there is a flat portion between adjoining raised portions 34Bp. The raised portions 34Bp have the shape of a cylinder with a conical portion on the air side. The typical height of the raised portions 34Bp, Dₕ, is not less than 50 nm and less than 500 nm. The raised portions 34Bp may be arranged regularly or may be arranged irregularly. When the raised portions 34Bp are arranged regularly, Dᵢₙₜ also represents the period of the arrangement. This also applies to the synthetic polymer film 34A, as a matter of course.

In this specification, the “moth-eye structure” includes not only surficial nanostructures that have an excellent antireflection function and that are formed by raised portions which have such a shape that the cross-sectional area (a cross section parallel to the film surface) increases as do the raised portions 34Ap of the synthetic polymer film 34A shown in FIG. 1A but also surficial nanostructures that are formed by raised portions which have a part where the cross-sectional area (a cross section parallel to the film surface) is constant as do the raised portions 34Bp of the synthetic polymer film 34B shown in FIG. 1B. Note that, from the viewpoint of breaking the cell walls and/or cell membranes of microorganisms, providing a conical portion is preferred. Note that, however, the tip end of the conical shape does not necessarily need to be a surficial nanostructure but may have a rounded portion (about 60 nm) which is generally equal to the nanopillars which form surficial nanostructures of the wings of cicadas.

A mold for forming the moth-eye structure such as illustrated in FIG. 1A and FIG. 1B over the surface (hereinafter, referred to as “moth-eye mold”) has an inverted moth-eye structure obtained by inverting the moth-eye structure. Using an anodized porous alumina layer which has the inverted moth-eye structure as a mold without any modification enables inexpensive production of the moth-eye structure. Particularly when a moth-eye mold in the shape of a hollow cylinder is used, the moth-eye structure can be efficiently manufactured according to a roll-to-roll method. Such a moth-eye mold can be manufactured according to methods disclosed in Japanese Laid-Open Patent Publication No. 2009-166502, WO 2011/125486 and WO 2013/183576.

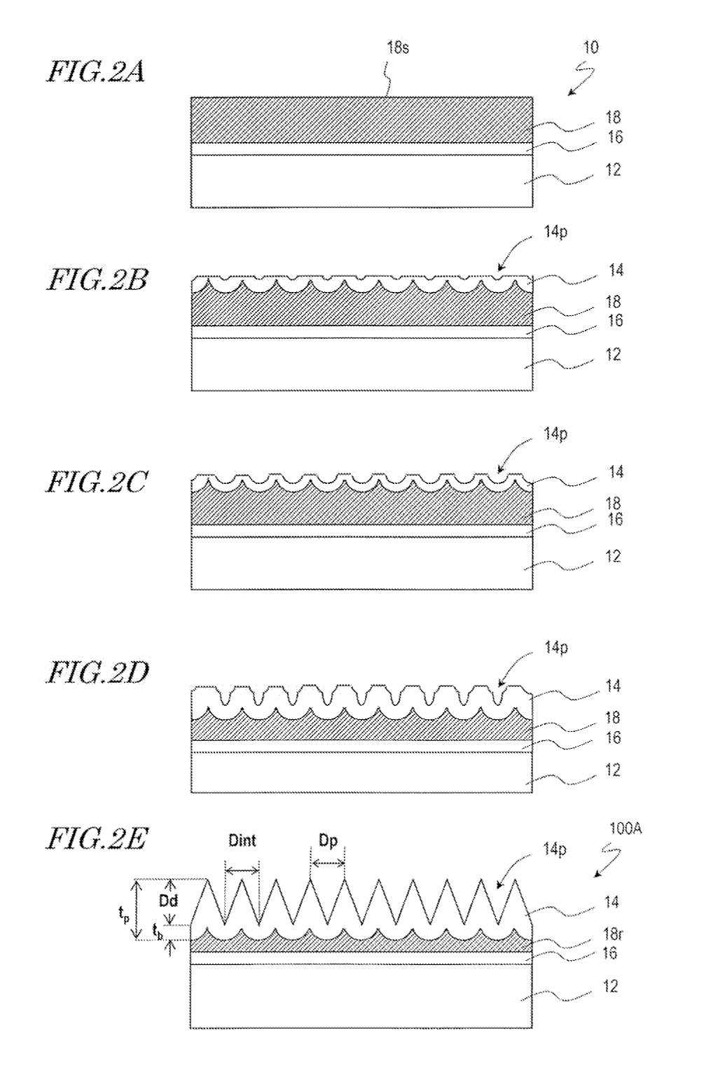

A manufacturing method of a moth-eye mold 100A that is for production of the synthetic polymer film 34A is described with reference to FIG. 2A, FIG. 2B, FIG. 2C, FIG. 2D, and FIG. 2E.

Firstly, a mold base 10 is provided which includes an aluminum base 12, an inorganic material layer 16 provided on a surface of the aluminum base 12, and an aluminum film 18 deposited on the inorganic material layer 16 as shown in FIG. 2A.

The aluminum base 12 used may be an aluminum base whose aluminum purity is not less than 99.50 mass % and less than 99.99 mass % and which has relatively high rigidity. The impurity contained in the aluminum base 12 may preferably include at least one element selected from the group consisting of iron (Fe), silicon (Si), copper (Cu), manganese (Mn), zinc (Zn), nickel (Ni), titanium (Ti), lead (Pb), tin (Sn) and magnesium (Mg). Particularly, Mg is preferred. Since the mechanism of formation of pits (hollows) in the etching step is a local cell reaction, the aluminum base 12 ideally does not contain any element which is nobler than aluminum. It is preferred that the aluminum base 12 used contains, as the impurity element, Mg (standard electrode potential: −2.36 V) which is a base metal. If the content of an element nobler than aluminum is 10 ppm or less, it can be said in terms of electrochemistry that the aluminum base 12 does not substantially contain the element. The Mg content is preferably 0.1 mass % or more of the whole. It is, more preferably, in the range of not more than about 3.0 mass %. If the Mg content is less than 0.1 mass %, sufficient rigidity cannot be obtained. On the other hand, as the Mg content increases, segregation of Mg is more likely to occur. Even if the segregation occurs near a surface over which a moth-eye mold is to be formed, it would not be detrimental in terms of electrochemistry but would be a cause of a defect because Mg forms an anodized film of a different form from that of aluminum. The content of the impurity element may be appropriately determined depending on the shape, thickness, and size of the aluminum base 12, in view of required rigidity. For example, when the aluminum base 12 in the form of a plate is prepared by rolling, the appropriate Mg content is about 3.0 mass %. When the aluminum base 12 having a three-dimensional structure of, for example, a hollow cylinder is prepared by extrusion, the Mg content is preferably 2.0 mass % or less. If the Mg content exceeds 2.0 mass %, the extrudability deteriorates in general.

The aluminum base 12 used may be an aluminum pipe in the shape of a hollow cylinder which is made of, for example, JIS A1050, an Al—Mg based alloy (e.g., JIS A5052), or an Al—Mg—Si based alloy (e.g., JIS A6063).

The surface of the aluminum base 12 is preferably a surface cut with a bit. If, for example, abrasive particles are remaining on the surface of the aluminum base 12, conduction will readily occur between the aluminum film 18 and the aluminum base 12 in a portion in which the abrasive particles are present. Not only in the portion in which the abrasive particles are remaining but also in a portion which has a roughened surface, conduction is likely to occur locally between the aluminum film 18 and the aluminum base 12. When conduction occurs locally between the aluminum film 18 and the aluminum base 12, there is a probability that a local cell reaction will occur between an impurity in the aluminum base 12 and the aluminum film 18.

The material of the inorganic material layer 16 may be, for example, tantalum oxide (Ta₂O₅) or silicon dioxide (SiO₂). The inorganic material layer 16 can be formed by, for example, sputtering. When a tantalum oxide layer is used as the inorganic material layer 16, the thickness of the tantalum oxide layer is, for example, 200 nm.

The thickness of the inorganic material layer 16 is preferably not less than 100 nm and less than 500 nm. If the thickness of the inorganic material layer 16 is less than 1.00 nm, there is a probability that a defect (typically, a void; i.e., a gap between crystal grains) occurs in the aluminum film 18. If the thickness of the inorganic material layer 16 is not less than 500 nm, insulation is likely to occur between the aluminum base 12 and the aluminum film 18 due to the surface condition of the aluminum base 12. To realize anodization of the aluminum film 18 by supplying an electric current from the aluminum base 12 side to the aluminum film 18, the electric current needs to flow between the aluminum base 12 and the aluminum film 18. When employing a configuration where an electric current is supplied from the inside surface of the aluminum base 12 in the shape of a hollow cylinder, it is not necessary to provide an electrode to the aluminum film 18. Therefore, the aluminum film 18 can be anodized across the entire surface, while such a problem does not occur that supply of the electric current becomes more difficult as the anodization advances. Thus, the aluminum film 18 can be anodized uniformly across the entire surface.

To form a thick inorganic material layer 16, it is in general necessary to increase the film formation duration. When the film formation duration is increased, the surface temperature of the aluminum base 12 unnecessarily increases, and as a result, the film quality of the aluminum film 18 deteriorates, and a defect (typically, a void) occurs in some cases. When the thickness of the inorganic material layer 16 is less than 500 nm, occurrence of such a problem can be suppressed.

The aluminum film 18 is, for example, a film which is made of aluminum whose purity is not less than 99.99 mass % (hereinafter, also referred to as “high-purity aluminum film”) as disclosed in WO 2011/125486. The aluminum film 18 is formed by, for example, vacuum evaporation or sputtering. The thickness of the aluminum film 18 is preferably in the range of not less than about 500 nm and not more than about 1500 nm. For example, the thickness of the aluminum film 18 is about 1 μm.

The aluminum film 18 may be an aluminum alloy film disclosed in WO 2013/183576 in substitution for the high-purity aluminum film. The aluminum alloy film disclosed in WO 2013/183576 contains aluminum, a metal element other than aluminum, and nitrogen. In this specification, the “aluminum film” includes not only the high-purity aluminum film but also the aluminum alloy film disclosed in WO 2013/183576.

Using the above-described aluminum alloy film can realize a specular surface whose reflectance is not less than 80%. The average grain diameter of crystal grains that form the aluminum alloy film when viewed in the normal direction of the aluminum alloy film is, for example, not more than 100 nm, and that the maximum surface roughness Rmax of the aluminum alloy film is not more than 60 nm. The content of nitrogen in the aluminum alloy film is, for example, not less than 0.5 mass % and not more than 5.7 mass %. It is preferred that the absolute value of the difference between the standard electrode potential of the metal element other than aluminum which is contained in the aluminum alloy film and the standard electrode potential of aluminum is not more than 0.64 V, and that the content of the metal element in the aluminum alloy film is not less than 1.0 mass % and not more than 1.9 mass %. The metal element is, for example, Ti or Nd. The metal element is not limited to these examples but may be such a different metal element that the absolute value of the difference between the standard electrode potential of the metal element and the standard electrode potential of aluminum is not more than 0.64 V (for example, Mn, Mg, Zr, V, and Pb). Further, the metal element may be Mo, Nb, or Hf. The aluminum alloy film may contain two or more of these metal elements. The aluminum alloy film is formed by, for example, a DC magnetron sputtering method. The thickness of the aluminum alloy film is also preferably in the range of not less than about 500 nm and not more than about 1500 nm. For example, the thickness of the aluminum alloy film is about 1 μm.

Then, a surface 18s of the aluminum film 18 is anodized to form a porous alumina layer 14 which has a plurality of recessed portions (micropores) 14p as shown in FIG. 2B. The porous alumina layer 14 includes a porous layer which has the recessed portions 14p and a barrier layer (the base of the recessed portions (micropores) 14p). As known in the art, the interval between adjacent recessed portions 14p (the distance between the centers) is approximately twice the thickness of the barrier layer and is approximately proportional to the voltage that is applied during the anodization. This relationship also applies to the final porous alumina layer 14 shown in FIG. 2E.

The porous alumina layer 14 is formed by, for example, anodizing the surface 18s in an acidic electrolytic solution. The electrolytic solution used in the step of forming the porous alumina layer 14 is, for example, an aqueous solution which contains an acid selected from the group consisting of oxalic acid, tartaric acid, phosphoric acid, sulfuric acid, chromic acid, citric acid, and malic acid. For example, the surface 18s of the aluminum film 18 is anodized with an applied voltage of 80 V for 55 seconds using an oxalic acid aqueous solution (concentration: 0.3 mass %, solution temperature: 10° C.), whereby the porous alumina layer 14 is formed.

Then, the porous alumina layer 14 is brought into contact with an alumina etchant such that a predetermined amount is etched away, whereby the opening of the recessed portions 14p is enlarged as shown in FIG. 2C. By modifying the type and concentration of the etching solution and the etching duration, the etching amount (i.e., the size and depth of the recessed portions 14p) can be controlled. The etching solution used may be, for example, an aqueous solution of 10 mass % phosphoric acid, organic acid such as formic acid, acetic acid or citric acid, or sulfuric acid, or a chromic/phosphoric acid solution. For example, the etching is performed for 20 minutes using a phosphoric acid aqueous solution (10 mass %, 30° C.).

Then, the aluminum film 18 is again partially anodized such that the recessed portions 14p are grown in the depth direction and the thickness of the porous alumina layer 14 is increased as shown in FIG. 2D. Here, the growth of the recessed portions 14p starts at the bottoms of the previously-formed recessed portions 14p, and accordingly, the lateral surfaces of the recessed portions 14p have stepped shapes.

Thereafter, when necessary, the porous alumina layer 14 may be brought into contact with an alumina etchant to be further etched such that the pore diameter of the recessed portions 14p is further increased. The etching solution used in this step may preferably be the above-described etching solution. Practically, the same etching bath may be used.

In this way, by alternately repeating the anodization step and the etching step as described above through multiple cycles (e.g., 5 cycles: including 5 anodization cycles and 4 etching cycles), the moth-eye mold 100A that includes the porous alumina layer 14 which has the inverted moth-eye structure is obtained as shown in FIG. 2E. Since the process is ended with the anodization step, the recessed portions 14p have pointed bottom portion. That is, the resultant mold enables formation of raised portions with pointed tip ends.

The porous alumina layer 14 (thickness: tₚ) shown in FIG. 2E includes a porous layer (whose thickness is equivalent to the depth D_{d} of the recessed portions 14p) and a barrier layer (thickness: tₚ). Since the porous alumina layer 14 has a structure obtained by inverting the moth-eye structure of the synthetic polymer film 34A, corresponding parameters which define the dimensions may sometimes be designated by the same symbols.

The recessed portions 14p of the porous alumina layer 14 may have, for example, a conical shape and may have a stepped lateral surface. It is preferred that the two-dimensional size of the recessed portions 14p (the diameter of a circle equivalent to the area of the recessed portions 14p when viewed in a normal direction of the surface), Dₚ, is more than 20 nm and less than 500 nm, and the depth of the recessed portions 14p, Dₚ, is not less than 50 nm and less than 1000 nm (1 μm). It is also preferred that the bottom portion of the recessed portions 14p is acute (with the deepest part of the bottom portion being pointed). When the recessed portions 14p are in a densely packed arrangement, assuming that the shape of the recessed portions 14p when viewed in a normal direction of the porous alumina layer 14 is a circle, adjacent circles overlap each other, and a saddle portion is formed between adjacent ones of the recessed portions 14p. Note that, when the generally-conical recessed portions 14p adjoin one another so as to form saddle portions, the two-dimensional size of the recessed portions 14p, Dₚ, is equal to the adjoining distance Dᵢₙₜ. The thickness of the porous alumina layer 14, tₚ, is not more than about 1 μm.

Under the porous alumina layer 14 shown in FIG. 2E, there is an aluminum remnant layer 18r. The aluminum remnant layer 18r is part of the aluminum film 18 which has not been anodized. When necessary, the aluminum film 18 may be substantially thoroughly anodized such that the aluminum remnant layer 18r is not present. For example, when the inorganic material layer 16 has a small thickness, it is possible to readily supply an electric current from the aluminum base 12 side.

The manufacturing method of the moth-eye mold illustrated herein enables manufacture of a mold which is for production of antireflection films disclosed in Japanese Laid-Open Patent Publication No. 2009-166502, WO 2011/125486 and WO 2013/183576. Since an antireflection film used in a high-definition display panel is required to have high uniformity, selection of the material of the aluminum base, specular working of the aluminum base, and control of the purity and components of the aluminum film are preferably carried out as described above. However, the above-described mold manufacturing method can be simplified because the microbicidal activity can be achieved without high uniformity. For example, the surface of the aluminum base may be directly anodized. Even if, in this case, pits are formed due to impurities contained in the aluminum base, only local structural irregularities occur in the moth-eye structure of the finally-obtained synthetic polymer film 34A, and it is estimated that there is little adverse influence on the microbicidal activity.

According to the above-described mold manufacturing method, a mold in which the regularity of the arrangement of the recessed portions is low, and which is suitable to production of an antireflection film, can be manufactured. In the case of utilizing the microbicidal ability of the moth-eye structure, it is estimated that the regularity of the arrangement of the raised portions does not exert an influence. A mold for formation of a moth-eye structure which has regularly-arranged raised portions can be manufactured, for example, as described in the following section.

For example, after formation of a porous alumina layer having a thickness of about 10 μm, the formed porous alumina layer is removed by etching, and then, anodization may be performed under the conditions for formation of the above-described porous alumina layer. A 10 μm thick porous alumina layer is realized by extending the anodization duration. When such a relatively thick porous alumina layer is formed and then this porous alumina layer is removed, a porous alumina layer having regularly-arranged recessed portions can be formed without being influenced by irregularities which are attributed to grains that are present at the surface of an aluminum film or aluminum base or the process strain. Note that, in removal of the porous alumina layer, using a chromic/phosphoric acid solution is preferred. Although continuing the etching for a long period of time sometimes causes galvanic corrosion, the chromic/phosphoric acid solution has the effect of suppressing galvanic corrosion.

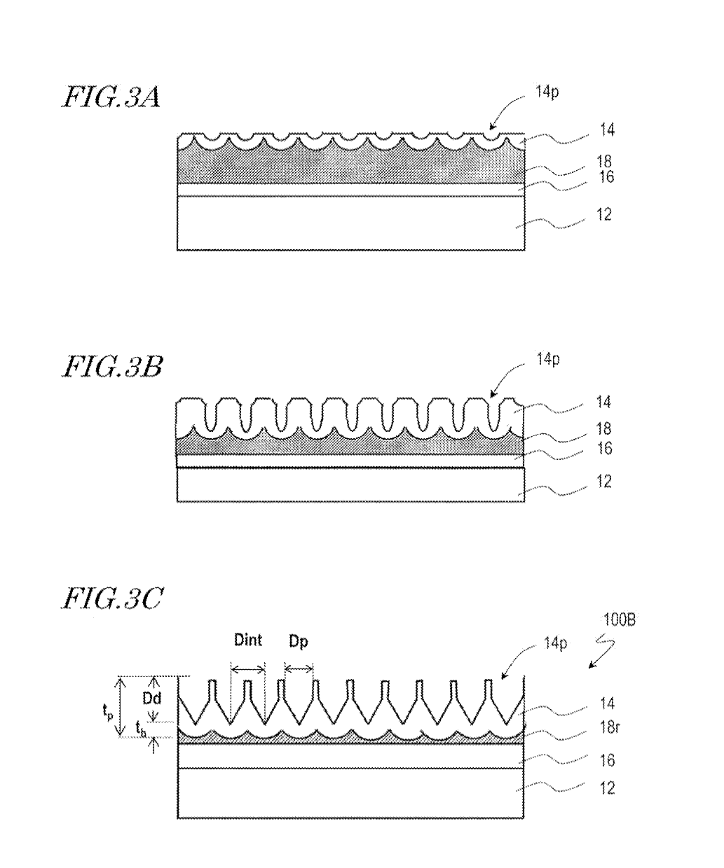

A moth-eye mold for production of the synthetic polymer film 34B shown in FIG. 1B can be, basically, manufactured by combination of the above-described anodization step and etching step. A manufacturing method of a moth-eye mold 100B that is for production of the synthetic polymer film 34B is described with reference to FIG. 3A, FIG. 3B, and FIG. 3C.

Firstly, in the same way as illustrated with reference to FIG. 2A and FIG. 2B, the mold base 10 is provided, and the surface 18s of the aluminum film 18 is anodized, whereby a porous alumina layer 14 which has a plurality of recessed portions (micropores) 14p is formed.

Then, the porous alumina layer 14 is brought into contact with an alumina etchant such that a predetermined amount is etched away, whereby the opening of the recessed portions 14p is enlarged as shown in FIG. 3A. In this step, the etched amount is smaller than in the etching step illustrated with reference to FIG. 2C. That is, the size of the opening of the recessed portions 14p is decreased. For example, the etching is performed for 10 minutes using a phosphoric acid aqueous solution (10 mass %, 30° C.).

Then, the aluminum film 18 is again partially anodized such that the recessed portions 14p are grown in the depth direction and the thickness of the porous alumina layer 14 is increased as shown in FIG. 3B. In this step, the recessed portions 14p are grown deeper than in the anodization step illustrated with reference to FIG. 2D. For example, the anodization is carried out with an applied voltage of 80 V for 165 seconds (in FIG. 2D, 55 seconds) using an oxalic acid aqueous solution (concentration: 0.3 mass %, solution temperature: 10° C.).

Thereafter, the etching step and the anodization step are alternately repeated through multiple cycles in the same way as illustrated with reference to FIG. 2E. For example, 3 cycles of the etching step and 3 cycles of the anodization step are alternately repeated, whereby the moth-eye mold 100B including the porous alumina layer 14 which has the inverted moth-eye structure is obtained as shown in FIG. 3C. In this step, the two-dimensional size of the recessed portions 14p, Dₚ, is smaller than the adjoining distance Dᵢₙₜ (Dₚ<Dᵢₙₜ).

The size of the microorganisms varies depending on their types. For example, the size of P. aeruginosa is about 1 μm. However, the size of the bacteria ranges from several hundreds of nanometers to about five micrometers. The size of fungi is not less than several micrometers. For example, it is estimated that raised portions whose two-dimensional size is about 200 nm have a microbicidal activity on a microorganism whose size is not less than about 0.5 μm, but there is a probability that the raised portions are too large to exhibit a sufficient microbicidal activity on a bacterium whose size is several hundreds of nanometers. The size of viruses ranges from several tens of nanometers to several hundreds of nanometers, and many of them have a size of not more than 100 nm. Note that viruses do not have a cell membrane but have a protein shell called capsid which encloses virus nucleic acids. The viruses can be classified into those which have a membrane-like envelope outside the shell and those which do not have such an envelope. In the viruses which have an envelope, the envelope is mainly made of a lipid. Therefore, it is expected that the raised portions likewise act on the envelope. Examples of the viruses which have an envelope include influenza virus and Ebola virus. In the viruses which do not have an envelope, it is expected that the raised portions likewise act on this protein shell called capsid. When the raised portions include nitrogen element, the raised portions can have an increased affinity for a protein which is made of amino acids.

In view of the above, the configuration and production method of a synthetic polymer film having raised portions which can exhibit a microbicidal activity against a microorganism of not more than several hundreds of nanometers are described below.

In the following description, raised portions of the above-described synthetic polymer film which have a two-dimensional size in the range of more than 20 nm and less than 500 nm are referred to as “first raised portions”. Raised portions which are superimposedly formed over the first raised portions are referred to as “second raised portions”. The two-dimensional size of the second raised portions is smaller than the two-dimensional size of the first raised portions and does not exceed 100 nm. Note that when the two-dimensional size of the first raised portions is less than 100 nm, particularly less than 50 nm, it is not necessary to provide the second raised portions. Recessed portions of the mold corresponding to the first raised portions are referred to as “first recessed portions”, and recessed portions of the mold corresponding to the second raised portions are referred to as “second recessed portions”.

When the method of forming the first recessed portions which have predetermined size and shape by alternately performing the anodization step and the etching step as described above is applied without any modification, the second recessed portions cannot be formed successfully.

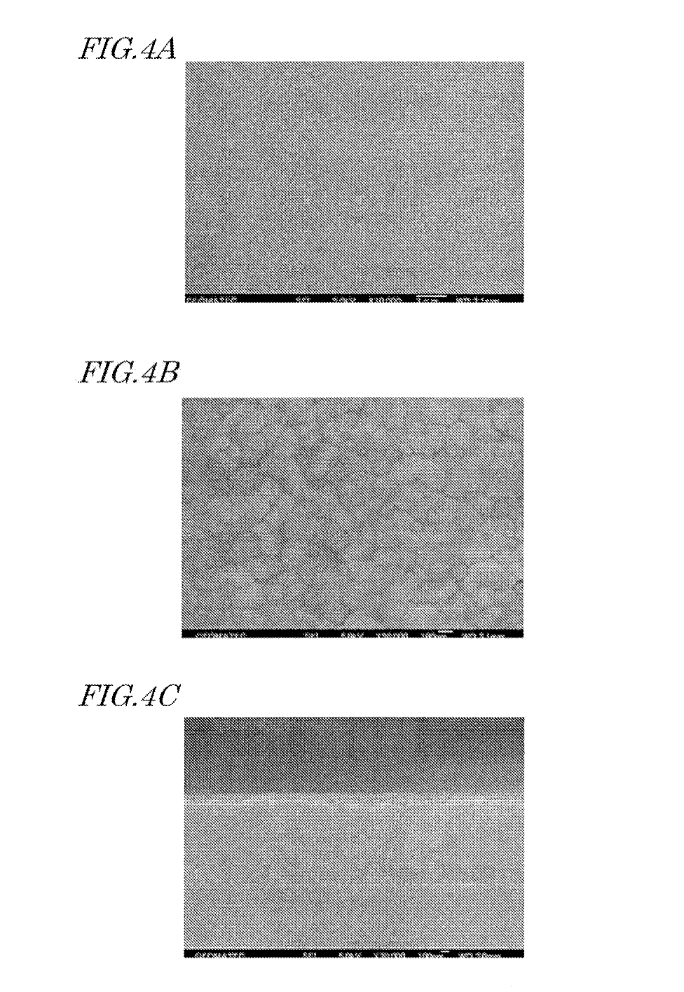

FIG. 4A shows a SEM image of a surface of an aluminum base (designated by reference numeral 12 in FIG. 2A). FIG. 4B shows a SEM image of a surface of an aluminum film (designated by reference numeral 18 in FIG. 2A). FIG. 4C shows a SEM image of a cross section of the aluminum film (designated by reference numeral 18 in FIG. 2A). As seen from these SEM images, there are grains (crystal grains) at the surface of the aluminum base and the surface of the aluminum film. The grains of the aluminum film form unevenness at the surface of the aluminum film. This unevenness at the surface affects formation of the recessed portions in the anodization and therefore interrupts formation of second recessed portions whose Dₚ or Dᵢₙₜ is smaller than 100 nm.

In view of the above, a method for manufacturing a mold which is used in production of a synthetic polymer film according to an embodiment of the present invention includes: (a) providing an aluminum base or an aluminum film deposited on a support; (b) the anodization step of applying a voltage at the first level while a surface of the aluminum base or aluminum film is kept in contact with an electrolytic solution, thereby forming a porous alumina layer which has the first recessed portions; (c) after step (b), the etching step of bringing the porous alumina layer into contact with an etching solution, thereby enlarging the first recessed portions; and (d) after step (c), applying a voltage at the second level that is lower than the first level while the porous alumina layer is kept in contact with an electrolytic solution, thereby forming the second recessed portions in the first recessed portions. For example, the first level is higher than 40 V, and the second level is equal to or lower than 20 V.

Specifically, an anodization step is carried out with the voltage at the first level, whereby the first recessed portions are formed which have such a size that is not influenced by the grains of the aluminum base or aluminum film. Thereafter, the thickness of the barrier layer is decreased by etching, and then, another anodization step is carried out with the voltage at the second level that is lower than the first level, whereby the second recessed portions are formed in the first recessed portions. When the second recessed portions are formed through such a procedure, the influence of the grains is avoided.

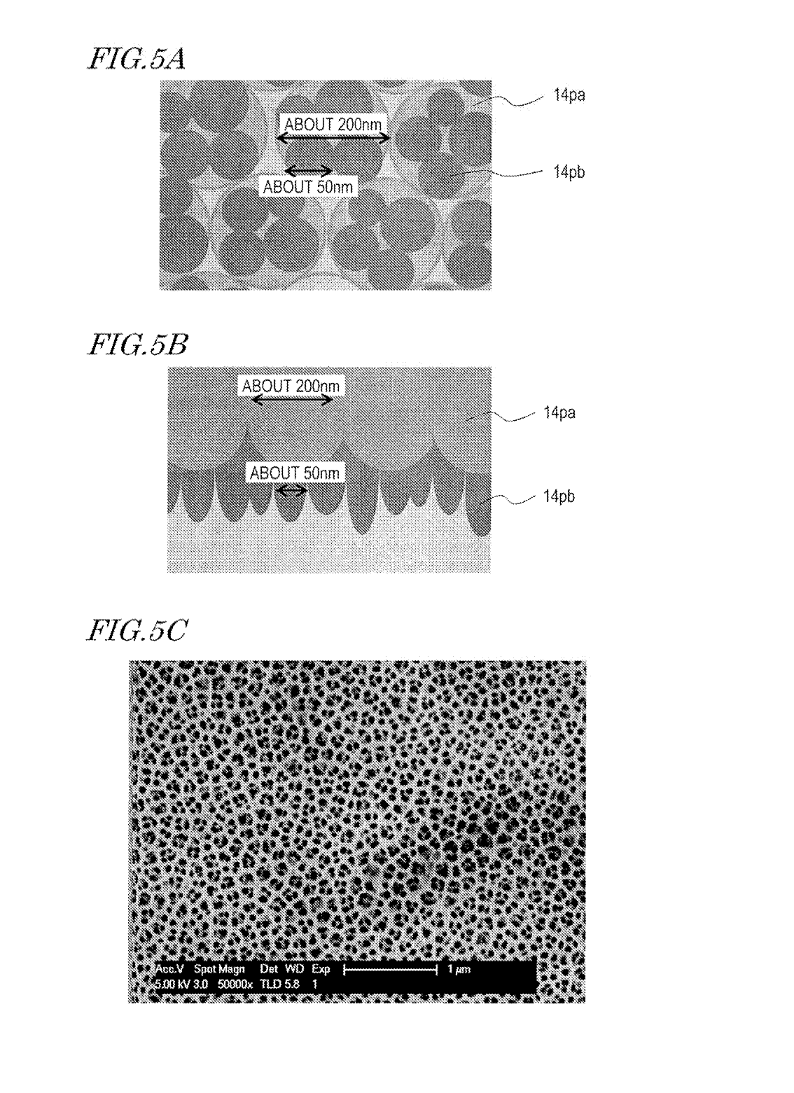

A mold which has first recessed portions 14pa and second recessed portions 14pb formed in the first recessed portions 14pa is described with reference to FIG. 5A, FIG. 5B, and FIG. 5C. FIG. 5A is a schematic plan view of a porous alumina layer of a mold. FIG. 5B is a schematic cross-sectional view of the porous alumina layer. FIG. 5C shows a SEM image of a prototype mold.

As shown in FIG. 5A and FIG. 5B, the surface of the mold of the present embodiment has the plurality of first recessed portions 14pa whose two-dimensional size is in the range of more than 20 nm and less than 500 nm and the plurality of second recessed portions 14pb which are superimposedly formed over the plurality of first recessed portions 14pa. The two-dimensional size of the plurality of second recessed portions 14pb is smaller than the two-dimensional size of the plurality of first recessed portions 14pa and does not exceed 100 nm. The height of the second recessed portions 14pb is, for example, more than 20 nm and not more than 100 nm. The second recessed portions 14pb preferably have a generally conical portion as do the first recessed portions 14pa.

The porous alumina layer shown in FIG. 5C was formed as described below.

The aluminum film used was an aluminum film which contains Ti at 1 mass %. The anodization solution used was an oxalic acid aqueous solution (concentration: 0.3 mass %, solution temperature: 10° C.). The etching solution used was a phosphoric acid aqueous solution (concentration: 10 mass %, solution temperature: 30° C.). After the anodization was carried out with a voltage of 80 V for 52 seconds, the etching was carried out for 25 minutes. Then, the anodization was carried out with a voltage of 80 V for 52 seconds, and the etching was carried out for 25 minutes. Thereafter, the anodization was carried out with a voltage of 20 V for 52 seconds, and the etching was carried out for 5 minutes. Further, the anodization was carried out with a voltage of 20 V for 52 seconds.

As seen from FIG. 5C, the second recessed portions whose Dₚ was about 50 nm were formed in the first recessed portions whose Dₚ was about 200 nm. When in the above-described manufacturing method the voltage at the first level was changed from 80 V to 45 V for formation of the porous alumina layer, the second recessed portions whose Dₚ was about 50 nm were formed in the first recessed portions whose Dₚ was about 100 nm.

When a synthetic polymer film is produced using such a mold, the produced synthetic polymer film has raised portions whose configuration is the inverse of that of the first recessed portions 14pa and the second recessed portions 14pb shown in FIG. 5A and FIG. 5B. That is, the produced synthetic polymer film further includes a plurality of second raised portions superimposedly formed over a plurality of first raised portions.

The thus-produced synthetic polymer film which has the first raised portions and the second raised portions superimposedly formed over the first raised portions has a microbicidal activity on various microorganisms, ranging from relatively small microorganisms of about 100 nm to relatively large microorganisms of not less than 5 μm.

As a matter of course, only raised portions whose two-dimensional size is in the range of more than 20 nm and less than 100 nm may be formed according to the size of a target microorganism. The mold for formation of such raised portions can be manufactured, for example, as described below.

The anodization is carried out using a neutral salt aqueous solution (ammonium borate, ammonium citrate, etc.), such as an ammonium tartrate aqueous solution, or an organic acid which has a low ionic dissociation degree (maleic acid, malonic acid, phthalic acid, citric acid, tartaric acid, etc.) to form a barrier type anodized film. After the barrier type anodized film is removed by etching, the anodization is carried out with a predetermined voltage (the voltage at the second level described above), whereby recessed portions whose two-dimensional size is in the range of more than 20 nm and less than 100 nm can be formed.

For example, an aluminum film which contains Ti at 1 mass % is anodized at 1.00 V for 2 minutes using a tartaric acid aqueous solution (concentration: 0.1 mol/l, solution temperature: 23° C.), whereby a barrier type anodized film is formed. Thereafter, the etching is carried out for 25 minutes using a phosphoric acid aqueous solution (concentration: 10 mass %, solution temperature: 30° C.), whereby the barrier type anodized film is removed. Thereafter, the anodization and the etching are alternatively repeated as described above, specifically through 5 anodization cycles and 4 etching cycles. The anodization was carried out at 20 V for 52 seconds using an oxalic acid aqueous solution (concentration: 0.3 mass %, solution temperature: 10° C.) as the anodization solution. The etching was carried out for 5 minutes using the above-described etching solution. As a result, recessed portions whose two-dimensional size is about 50 nm can be uniformly formed.

Moth-eye molds which are capable of forming various moth-eye structures can be manufactured as described above.

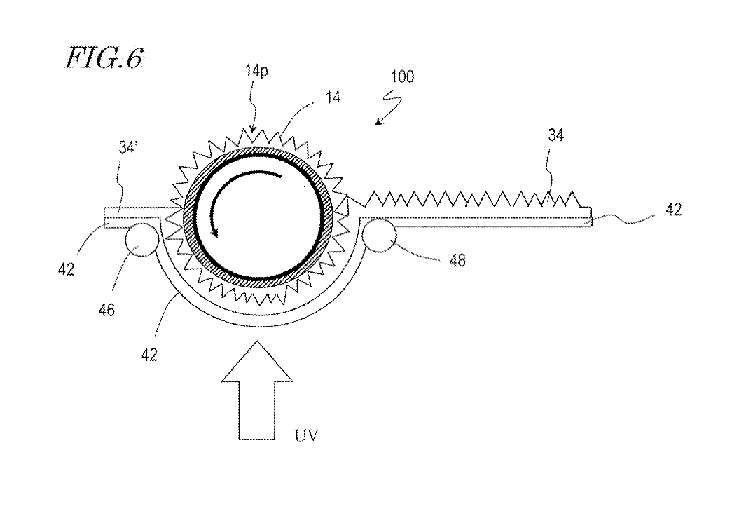

Next, a method for producing a synthetic polymer film with the use of a moth-eye mold 100 is described with reference to FIG. 6. FIG. 6 is a schematic cross-sectional view for illustrating a method for producing a synthetic polymer film according to a roll-to-roll method. In the following paragraphs, a method for producing a synthetic polymer film over a surface of a base film as a work using the above-described roll mold will be described. However, a synthetic polymer film production method according to an embodiment of the present invention is not limited to this example but is capable of producing a synthetic polymer film over a surface of various types of works using a mold of a different shape.

First, a moth-eye mold 100 in the shape of a hollow cylinder is provided. Note that the moth-eye mold 100 in the shape of a hollow cylinder is manufactured according to, for example, the manufacturing method described with reference to FIG. 2A, FIG. 2B, FIG. 2C, FIG. 2D, and FIG. 2E.

As shown in FIG. 6, a base film 42 over which a UV-curable resin 34′ is applied on its surface is maintained pressed against the moth-eye mold 100, and the UV-curable resin 34′ is irradiated with ultraviolet (UV) light such that the UV-curable resin 34′ is cured. The UV-curable resin 34′ used may be, for example, an acrylic resin. The base film 42 is fed from an unshown feeder roller, and thereafter, the UV-curable resin 34′ is applied over the surface of the base film 42 using, for example, a slit coater or the like. The base film 42 is supported by supporting rollers 46 and 48 as shown in FIG. 6. The supporting rollers 46 and 48 have rotation mechanisms for carrying the base film 42. The moth-eye mold 100 in the shape of a hollow cylinder is rotated at a rotation speed corresponding to the carrying speed of the base film 42 in a direction indicated by the arrow in FIG. 6.

Thereafter, the moth-eye mold 100 is separated from the base film 42, whereby a synthetic polymer film 34 to which the inverted moth-eye structure of the moth-eye mold 100 is transferred is formed on the surface of the base film 42. The base film 42 which has the synthetic polymer film 34 formed on the surface is wound up by an unshown winding roller.

The surface of the synthetic polymer film 34 has the moth-eye structure obtained by inverting the surficial nanostructures of the moth-eye mold 100. According to the surficial nanostructure of the moth-eye mold 100 used, the synthetic polymer films 34A and 34B shown in FIG. 1A and FIG. 1B, respectively, can be produced. The material that forms the synthetic polymer film 34 is not limited to the UV-curable resin but may be a photocurable resin which is curable by visible light or may be a thermosetting resin.

The microbicidal ability of a synthetic polymer film which has the moth-eye structure over its surface has not only a correlation with the physical structure of the synthetic polymer film but also a correlation with the chemical properties of the synthetic polymer film. For example, the present applicant found correlations with chemical properties, such as a correlation with the contact angle of the surface of the synthetic polymer film (WO 2015/163018), a correlation with the concentration of the nitrogen element contained in the surface (WO 2016/080245), and a correlation with the content of ethylene oxide units (—CH₂CH₂O—) in addition to the nitrogen element concentration (WO 2016/208540).

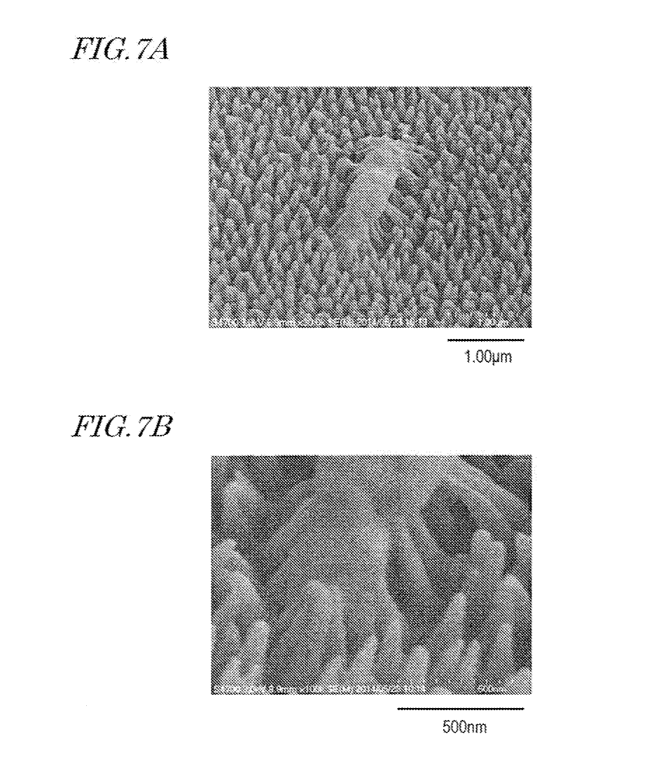

FIG. 7A and FIG. 7B show SEM images disclosed in WO 2016/080245 (FIG. 8). FIG. 7A and FIG. 7B show SEM images obtained by SEM (Scanning Electron Microscope) observation of a P. aeruginosa bacterium which died at the surface which had the moth-eye structure shown in FIG. 1A.

As seen from these SEM images, the tip end portions of the raised portions enter the cell wall (exine) of a P. aeruginosa bacterium. In FIG. 7A and FIG. 7B, the raised portions do not appear to break through the cell wall but appears to be taken into the cell wall. This might be explained by the mechanism suggested in the “Supplemental Information” section of Ivanova, E. P. et al. That is, it is estimated that the exine (lipid bilayer) of the Gram-negative bacteria came close to the raised portions and deformed so that the lipid bilayer locally underwent a transition like a first-order phase transition (spontaneous reorientation) and openings were formed in portions close to the raised portions, and the raised portions entered these openings. Alternatively, it is estimated that the raised portions were taken in due to the cell's mechanism of taking a polar substance (including a nutrient source) into the cell (endocytosis).

According to research carried out by the present inventors, it was found that the synthetic polymer films disclosed in WO 2015/163018, WO 2016/080245 and WO 2016/208540 have sufficient adhesion to PET (polyethylene terephthalate) and TAC (triacetyl cellulose) but insufficient adhesion to PC (polycarbonate). Since a PET or TAC film is conventionally used as the base films 42A and 42B, the compositions of the conventional synthetic polymer films cannot achieve sufficient adhesion to the PC film. PC is a resin which generally exhibits high physical properties among engineering plastics and has been widely used particularly because of its excellent shock resistance and heat resistance. In the following section, an embodiment of a synthetic polymer film whose surface has a microbicidal activity and which has improved adhesion to PC is described.

Also, the present inventors further studied a synthetic polymer film which is suitably used for sterilization of a solution including water and found that the synthetic polymer films disclosed in WO 2015/163018, WO 2016/080245 and WO 2016/208540 still have room for improvement in mass productivity (transferability) and/or water resistance. One of the possible reasons is that an acrylate which contains a nitrogen element (which is, for example, a constituent of a urethane bond) and/or a fluorine element is used in the synthetic polymer films disclosed in WO 2015/163018, WO 2016/080245 and WO 2016/208540. In view of such, the present inventors developed a synthetic polymer film of which the crosslink structure does not contain a nitrogen element (which is, for example, a constituent of a urethane bond) or a fluorine element (International Application No. PCT/JP2018/030788). The entire disclosure of International Application No. PCT/JP2018/030788 is incorporated by reference in this specification.

In the following section, as a molded product which includes a synthetic polymer film whose surface has a microbicidal activity, a molded product which includes a PC base film and a synthetic polymer film provided on the PC base film will be described as an example. However, the present invention is not limited to this example. A PC molded product which has an arbitrary shape can be used as the base. The base is not limited to a PC molded product. The base only needs to include PC at a surface on which at least a synthetic polymer film is to be provided.

When a PC film is used as the base, mass production is possible according to the above-described roll-to-roll method. Therefore, it is preferred to use a synthetic polymer film of which the crosslink structure does not contain a nitrogen element (which is a constituent of a urethane bond) or a fluorine element. As a matter of course, when any other manufacturing method is employed, the crosslink structure may contain a nitrogen element (which is a constituent of a urethane bond) or a fluorine element.

[Synthetic Polymer Film]

Sample films which had the same configuration as the film 50A shown in FIG. 1A were produced using UV-curable resins of different compositions.

The base film 42A used was a polycarbonate film. Specifically, a 110 μm thick film of “Iupilon KS3410UR” manufactured by Mitsubishi Engineering-Plastics Corporation was used (Tupilon is a registered trademark). Besides, “CARBOGLASS (registered trademark)” manufactured by AGC Inc., “PUREACE (registered trademark)” manufactured by TEIJIN LIMITED, “Makrofol (registered trademark)” manufactured by Covestro, or the like can also be used.

The materials used for formation of the synthetic polymer films are shown in TABLE 1. Herein, a synthetic polymer film of Reference Example 1 which contained a nitrogen element (which was a constituent of a urethane bond) as the synthetic polymer films disclosed in WO 2015/163018, WO 2016/080245 and WO 2016/208540, synthetic polymer films of Examples 1 to 14 of which the adhesion to PC was improved, and synthetic polymer films of Comparative Examples 1 to 9 were produced. The composition of Reference Example 1 is shown in TABLE 2. The compositions of Examples 1 to 14 are shown in TABLE 3. The compositions of Comparative Examples 1 to 9 are shown in TABLE 4. The present inventors studied various acrylic monomers which were expected to provide the effect of improving the adhesion to a PC film and found that 2-(2-vinyloxy ethoxy) ethyl acrylate is effective. Herein, VEEA manufactured by NIPPON SHOKUBAI CO., LTD. was used as 2-(2-vinyloxy ethoxy)ethyl acrylate.

The same synthetic polymer film production method as that previously described with reference to FIG. 6 was used to produce a synthetic polymer film 34A which had the moth-eye structure over the surface with the use of the moth-eye mold 100A.

For the moth-eye mold 100A, an aluminum film (thickness: about 1 μm) was formed on a glass substrate (about 5 cm×about 5 cm), and anodization and etching were performed alternately and repeatedly on the aluminum film, whereby a porous alumina layer (Dₚ was about 200 nm, Dᵢₙₜ was about 200 nm, and Dₕ was about 150 nm) which is the same as that previously described was formed.

UV-curable resins of different compositions were applied to the moth-eye mold 100A while the moth-eye mold 100A was heated to 20° C. or 40° C. on a hot stage. On the moth-eye mold 100A to which the UV-curable resin was applied, a PC film was placed and evenly pressed against the mold using a hand roller. Then, the UV-curable resin is irradiated with ultraviolet light from the PC film side so as to be cured, whereby a sample film including a synthetic polymer film on the PC film was obtained. The exposure amount was about 200 mJ/cm² (on the basis of light at the wavelength of 375 nm). In the ultraviolet light irradiation, a UV lamp manufactured by Fusion UV Systems (product name: LIGHT HANMAR6J6P3) was used. The process of producing a synthetic polymer film on a PC film is also referred to as “transfer process”. The temperature in that process (20° C. or 40° C.) is also referred to as “transfer temperature”. In each sample film, Dₚ was about 200 nm, Dᵢₙₜ was about 200 nm, and Dₕ was about 150 nm. In each sample, the synthetic polymer film was produced without using a solvent.

TABLE 1

| | | | | | | | | number | |
|---|---|---|---|---|---|---|---|---|---|
| | | | | | Water | | | of | EO |
| | | | Manufacturer | Compound | Solu- | EO | | moles | mass |
| MATERIALS | Abbreviation | Product Name | Name | Name | bility | group | MW | of EO | % |
| Acrylic | UV7600 | UV-7600V | The Nippon | urethane acrylate | NO | unknown | unknown | — | — |
| Monomer | | | Synthetic | | | | | | |
| | | | Chemical | | | | | | |
| | | | Industry | | | | | | |
| | | | Co., Ltd. | | | | | | |
| | SR601 | SR-601 | ARKEMA | bisphenol A | NO | YES | 512 | 4 | 34 |
| | | | | ethoxylate | | | | | |
| | | | | diacrylate | | | | | |
| | UA7100 | UA-7100 | Shin | urethane acrylate | YES | YES | 1907 | 27 | 62 |
| | | | Nakamura | | | | | | |
| | | | Chemical | | | | | | |
| | | | Co., Ltd. | | | | | | |
| | ATM35E | ATM-35E | Shin | ethoxylated | YES | YES | 1894 | 35 | 81 |
| | | | Nakamura | pentaerythritol | | | | | |
| | | | Chemical | tetraacrylate | | | | | |
| | | | Co., Ltd. | | | | | | |
| | A400 | A-400 | Shin | polyethylene glycol | YES | YES | 508 | 9 | 78 |
| | | | Nakamura | (400) diacrylate | | | | | |
| | | | Chemical | | | | | | |
| | | | Co., Ltd. | | | | | | |
| | A200 | A-200 | Shin | polyethylene glycol | YES | YES | 308 | 4 | 57 |
| | | | Nakamura | (200) diacrylate | | | | | |
| | | | Chemical | | | | | | |
| | | | Co., Ltd. | | | | | | |
| | VEEA | VEEA | NIPPON | 2-(2-vinyloxy | NO | YES | 186 | 2 | 47 |
| | | | SHOKUBAI | ethoxy)ethyl | | | | | |
| | | | CO., LTD. | acrylate | | | | | |
| | ATMM3LMN | A-TMM-3LM-N | Shin | pentaerythritol | NO | NO | 298 | — | — |
| | | | Nakamura | triacrylate | | | | | |
| | | | Chemical | | | | | | |
| | | | Co., Ltd. | | | | | | |
| | ATMPT | ATMPT | Shin | trimethylolpropane | NO | NO | 296 | — | — |
| | | | Nakamura | triacrylate | | | | | |
| | | | Chemical | | | | | | |
| | | | Co., Ltd. | | | | | | |
| | PO-A | PO-A | Kyoeisha | phenoxyethyl | NO | NO | 192 | — | — |
| | | | Chemical | acrylate | | | | | |
| | | | Co., Ltd. | | | | | | |
| | 4HBA | 4HBA | Nippon Kasei | 4-hydroxybutyl | YES | NO | 144 | — | — |
| | | | Chemical | acrylate | | | | | |
| | | | Co., Ltd. | | | | | | |
| | ACMO | ACMO | KJ Chemicals | N,N- | YES | NO | 141 | — | — |
| | | | Corporation | acryloylmorpholine | | | | | |
| | THFA | Viscoat#150, | Osaka | tetrahydrofurfuryl | NO | NO | 156 | — | — |
| | | THFA | Organic | acrylate | | | | | |
| | | | Chemical | | | | | | |
| | | | Industry | | | | | | |
| | | | Ltd. | | | | | | |
| | ME-3 | ME-3 | DKS Co. Ltd. | methoxytriethylene | YES | YES | 228 | 3 | 58 |
| | | | | glycol acrylate | | | | | |
| | VEEM | VEEM | NIPPON | 2-(2-vinyloxy | NO | YES | 200 | 2 | 44 |
| | | | SHOKUBAI | ethoxy)ethyl | | | | | |
| | | | CO., LTD. | methacrylate | | | | | |
| Poly- | TPO | IRGACURE TPO | ISM Resins | diphenyl(2,4,6- | — | — | — | — | — |
| merization | | | | trimethylbenzoyl) | | | | | |
| Initiator | | | | phosphine oxide | | | | | |
| | 819 | IRGACURE 819 | ISM Resins | bis(2,4,6- | — | — | — | — | — |
| | | | | trimethylbenzoyl)- | | | | | |
| | | | | phenylphosphine | | | | | |
| | | | | oxide | | | | | |

TABLE 2

| | | |
|---|---|---|
| REFERENCE | Acrylic Monomer | Initiator |

| EXAMPLES | UA7100 | ATM35E | 819 | TPO |
|---|---|---|---|---|
| Reference | 27.7% | 69.3% | 1.5% | 1.5% |
| Example 1 | | | | |

TABLE 3

| | Acrylic Monomer | | | | | | | | Initiator | |
|---|---|---|---|---|---|---|---|---|---|---|
| EXAMPLES | ATM35E | A400 | A200 | VEEA | ATMPT | ACMO | THFA | ME-3 | 819 | TPO |
| Example 1 | | 38.8% | | 29.1% | | 29.1% | | | 1.5% | 1.5% |
| Example 2 | 38.8% | | | 29.1% | | 29.1% | | | 1.5% | 1.5% |
| Example 3 | 38.8% | | | 29.1% | | | 29.1% | | 1.5% | 1.5% |
| Example 4 | | 34.0% | | 34.0% | | 29.1% | | | 1.5% | 1.5% |
| Example 5 | | 38.8% | | 19.4% | 9.7% | 29.1% | | | 1.5% | 1.5% |
| Example 6 | | 43.7% | | 14.6% | 9.7% | 29.1% | | | 1.5% | 1.5% |
| Example 7 | | 34.0% | | 41.7% | 9.7% | 11.7% | | | 1.5% | 1.5% |
| Example 8 | | 29.1% | | 29.1% | 9.7% | 29.1% | | | 1.5% | 1.5% |
| Example 9 | | 34.0% | | 24.3% | 9.7% | 29.1% | | | 1.5% | 1.5% |
| Example 10 | | 38.8% | | 38.8% | 9.7% | 9.7% | | | 1.5% | 1.5% |
| Example 11 | | 36.9% | | 24.3% | 6.8% | 9.7% | | 19.4% | 1.5% | 1.5% |
| Example 12 | | 41.3% | 9.7% | 43.7% | | 2.4% | | | 1.5% | 1.5% |
| Example 13 | | 63.1% | | 34.0% | | | | | 1.5% | 1.5% |
| Example 14 | | 72.8% | | 24.3% | | | | | 1.5% | 1.5% |

TABLE 4

| COMPARATIVE | Acrylic Monomer | | | | | | | | | Initiator | |
|---|---|---|---|---|---|---|---|---|---|---|---|
| EXAMPLES | UA7100 | ATM35E | A400 | VEEA | ATMM3LMN | ATMPT | 4HBA | ACMO | THFA | 819 | TPO |
| Comparative | 50.3% | | | | 17.7% | | | 29.1% | | 1.5% | 1.5% |
| Example 1 | | | | | | | | | | | |
| Comparative | | 50.3% | | | 17.7% | | | 29.1% | | 1.5% | 1.5% |
| Example 2 | | | | | | | | | | | |
| Comparative | | | 50.3% | | 17.7% | | 29.1% | | | 1.5% | 1.5% |
| Example 3 | | | | | | | | | | | |
| Comparative | | | 58.3% | | | 9.7% | | 29.1% | | 1.5% | 1.5% |
| Example 4 | | | | | | | | | | | |
| Comparative | | | 48.5% | 9.7% | | 9.7% | | 29.1% | | 1.5% | 1.5% |
| Example 5 | | | | | | | | | | | |
| Comparative | | | 48.5% | 9.7% | | 9.7% | | | 29.1% | 1.5% | 1.5% |
| Example 6 | | | | | | | | | | | |
| Comparative | | | 34.0% | 48.5% | | 9.7% | | 4.9% | | 1.5% | 1.5% |
| Example 7 | | | | | | | | | | | |
| Comparative | | | 24.3% | 24.3% | | 19.4% | | 29.1% | | 1.5% | 1.5% |
| Example 8 | | | | | | | | | | | |
| Comparative | | | 82.5% | 14.6% | | | | | | 1.5% | 1.5% |
| Example 9 | | | | | | | | | | | |

Evaluation results of the respective sample films as to the microbicidal ability and the adhesion to the PC film (PC adhesion) are shown in TABLE 5 to TABLE 7. TABLE 5 shows the results of Reference Example 1. TABLE 6 shows the results of Examples 1 to 14. TABLE 7 shows the results of Comparative Examples 1 to 9.

TABLE 5 to TABLE 7 also show the proportion of the contained ethylene oxide unit (EO unit) to the entirety of the synthetic polymer film (EO content (mass %)) and the proportion of the contained 2-(2-vinyloxy ethoxy) ethyl acrylate monomer unit to the entirety of the synthetic polymer film (VEEA content (mass %)). In each synthetic polymer film, the EO unit and the 2-(2-vinyloxy ethoxy) ethyl acrylate monomer unit are each contained as an acrylic monomer and are therefore contained in the crosslink structure of a finally-obtained synthetic polymer film.

[Evaluation of Microbicidal Ability]

The sample films were evaluated as to the microbicidal ability for the bacterial solution (water) sprinkled over the sample films. The sample films to which the bacterial solution was applied and which were left in atmospheric air at room temperature were evaluated as to the microbicidal ability. Therefore, the results include an influence of drying. Herein, the microbicidal ability for Staphylococcus aureus was evaluated. A specific evaluation method is described in the following paragraphs. For each sample film, an experiment was carried out with N=3.

(1) A bacterial solution including Staphylococcus aureus was prepared using 1/500 NB culture medium such that the initial bacteria count was 1E+06 CFU/mL.

(2) On each sample film (a square of 5 cm on each side), 10 μL of the above-described bacterial solution was dropped.

(3) The sample films were left in atmospheric air at room temperature (about 25° C.) for 15 minutes and, thereafter, a SCDLP culture medium was flowed over the sample films to wash away the bacteria (post-wash solution).

(4) The post-wash solution was appropriately diluted with PBS and cultured in the standard agar medium, and the number of bacteria was counted.

The microbicidal ability was evaluated relative to the microbicidal ability of a reference film. The reference film used was a 50 μm thick PET film (A4300 manufactured by TOYOBO CO., LTD.). For the PET film, the number of bacteria was counted through the above-described procedure. Each of the sample films was evaluated as to the microbicidal ability in the proportion (%) of the number of bacteria on each sample film to the number of bacteria on the PET film. Specifically, the bacteria survival rate was calculated by the following formula:

Bacteria Survival Rate (%)=Number of bacteria on each sample film (aggregate of N=3)/Number of bacteria on PET film (aggregate of N=3)×100

The criteria for judgement as to the microbicidal ability were based on the bacteria survival rate such that ●: 0%, ∘: more than 0% and less than 10%, Δ: not less than 10% and less than 50%, x: not less than 50%. Specifically, when the bacteria survival rate was less than 50%, the sample film was judged to be usable.

[Evaluation of Adhesion to PC Film]

The adhesion to the PC film was evaluated as described in the following paragraphs.

In an environment where the temperature was 23° C. and the humidity was 50%, 11 vertical incisions and 11 horizontal incisions were formed in a surface of a synthetic polymer film of each sample film (a surface opposite to the base) using a utility knife at intervals of 1 mm in the shape of a grid such that 100 squares (1 mm on each side) were formed. Then, a polyester adhesive tape “No. 31B” manufactured by NITTO DENKO CORPORATION was placed on and pressed against the square portions. Thereafter, the adhesive tape was peeled off in a direction of 90° with respect to the surface of the square portions at a velocity of 100 mm/s. Thereafter, the surface state of the synthetic polymer film on the base was visually observed, and the number of squares from which the polymer layer on the base was not removed, M, was counted. The criteria for judgement were as follows.

∘: M=100

Δ: M=95 to 99

x: M=0 to 94

The adhesion was judged as follows based on the judgement at 20° C. and 40° C.

●: ∘ at 20° C. and ∘ at 40° C.

∘: Δ at 20° C. and ∘ at 40° C.

Δ: x at 20° C. and ∘ at 40° C.

x: x at 20° C. and Δ at 40° C.

xx: x at 20° C. and x at 40° C.

When the adhesion was judged as ●, ∘ or Δ, the adhesion was judged to be at a tolerable level (excellent adhesion).

TABLE 5

| | | | PC Adhesion | | | | | | |
|---|---|---|---|---|---|---|---|---|---|
| | | | Transfer | | Transfer | | | | |
| | | | Temperature: | | Temperature: | | | | |
| | | | 20° C. | | 40° C. | | | Microbicidal | |
| | | | Number of | | Number of | | | Ability | |
| | | | remaining | | remaining | | | Bacteria | |
| | EO | VEEA | squares | | squares | | | Survival | |
| REFERENCE | content | content | (out of | | (out of | | | Rate | |
| EXAMPLES | (%) | (%) | 100) | Judge | 100) | Judge | Judge | (%) | Judge |
| Reference | 74% | — | 0 | x | 0 | x | xx | 0% | ● |
| Example 1 | | | | | | | | | |

TABLE 6

| | | | PC Adhesion | | | | | | |
|---|---|---|---|---|---|---|---|---|---|
| | | | Transfer | | Transfer | | | | |
| | | | Temperature: | | Temperature: | | | | |
| | | | 20° C. | | 40° C. | | | Microbicidal | |
| | | | Number of | | Number of | | | Ability | |
| | | | remaining | | remaining | | | Bacteria | |
| COM- | EO | VEEA | squares | | squares | | | Survival | |
| PARATIVE | content | content | (out of | | (out of | | | Rate | |
| EXAMPLES | (%) | (%) | 100) | Judge | 100) | Judge | Judge | (%) | Judge |
| Example 1 | 44% | 29.1% | 100 | ∘ | 100 | ∘ | ● | 0% | ● |
| Example 2 | 45% | 29.1% | 100 | ∘ | 100 | ∘ | ● | 0% | ● |
| Example 3 | 45% | 29.1% | 100 | ∘ | 100 | ∘ | ● | 0% | ● |
| Example 4 | 43% | 34.0% | 100 | ∘ | 100 | ∘ | ● | 0% | ● |
| Example 5 | 39% | 19.4% | 99 | Δ | 100 | ∘ | ∘ | 7% | ∘ |
| Example 6 | 41% | 14.6% | 96 | Δ | 100 | ∘ | ∘ | 0% | ● |
| Example 7 | 46% | 41.7% | 100 | ∘ | 100 | ∘ | ● | 43% | Δ |
| Example 8 | 36% | 29.1% | 100 | ∘ | 100 | ∘ | ● | 46% | Δ |
| Example 9 | 38% | 24.3% | 100 | ∘ | 100 | ∘ | ● | 29% | Δ |
| Example 10 | 49% | 38.8% | 95 | Δ | 100 | ∘ | ∘ | 5% | ∘ |
| Example 11 | 51% | 24.3% | 25 | x | 100 | ∘ | Δ | 0% | ● |
| Example 12 | 58% | 43.7% | 95 | Δ | 100 | ∘ | ∘ | 36% | Δ |
| Example 13 | 65% | 34.0% | 15 | x | 100 | ∘ | Δ | 0% | ● |
| Example 14 | 68% | 24.3% | 0 | x | 100 | ∘ | Δ | 0% | ● |

TABLE 7

| | | | PC Adhesion | | | | | | |
|---|---|---|---|---|---|---|---|---|---|
| | | | Transfer | | Transfer | | | | |
| | | | Temperature: | | Temperature: | | | | |
| | | | 20° C. | | 40° C. | | | Microbicidal | |
| | | | Number of | | Number of | | | Ability | |
| | | | remaining | | remaining | | | Bacteria | |
| | EO | VEEA | squares | | squares | | | Survival | |
| | content | content | (out of | | (out of | | | Rate | |
| EXAMPLES | (%) | (%) | 100) | Judge | 100) | Judge | Judge | (%) | Judge |
| Comparative | 31% | | 0 | x | 0 | x | xx | 0% | ● |
| Example 1 | | | | | | | | | |
| Comparative | 41% | | 0 | x | 0 | x | xx | 0% | ● |
| Example 2 | | | | | | | | | |
| Comparative | 39% | | 0 | x | 0 | x | xx | 0% | ● |
| Example 3 | | | | | | | | | |
| Comparative | 45% | | 0 | x | 0 | x | xx | 0% | ● |
| Example 4 | | | | | | | | | |
| Comparative | 42% | 9.7% | 0 | x | 54 | x | xx | 0% | ● |
| Example 5 | | | | | | | | | |
| Comparative | 42% | 9.7% | 0 | x | 59 | x | xx | 0% | ● |
| Example 6 | | | | | | | | | |
| Comparative | 49% | 48.5% | 100 | ∘ | 100 | ∘ | ● | 71% | x |
| Example 7 | | | | | | | | | |
| Comparative | 30% | 24.3% | 100 | ∘ | 100 | ∘ | ● | 82% | x |
| Example 8 | | | | | | | | | |
| Comparative | 71% | 14.6% | 0 | x | 23 | x | xx | 0% | ● |
| Example 9 | | | | | | | | | |

As seen from TABLE 5, Reference Example 1 which contains a nitrogen element (which is a constituent of a urethane bond) has excellent microbicidal ability but poor PC adhesion.

Next, see TABLE 6.

The synthetic polymer films of Examples 1 to 14 contain none of a nitrogen element. (which is a constituent of a urethane bond) and a fluorine element in the crosslink structure. A nitrogen element contained in ACMO is a constituent of a tertiary amine, and its polarity is not strong as compared with primary and secondary amines.

The proportion of the contained ethylene oxide unit to the entirety of the synthetic polymer film is not less than 35 mass % and less than 70 mass %. The proportion of the contained 2-(2-vinyloxy ethoxy) ethyl acrylate monomer unit to the entirety of the synthetic polymer film is not less than 15 mass % and less than 45 mass %. The sample films of Examples 1 to 14 have excellent PC adhesion and have microbicidal ability. Some of the sample films of Examples 1 to 1.4 in which the proportion of the contained 2-(2-vinyloxy ethoxy) ethyl acrylate monomer unit is less than 40 mass % have excellent microbicidal ability. From the viewpoint of the microbicidal ability, the proportion of the contained ethylene oxide unit is preferably more than 40 mass %. From the viewpoint of the PC adhesion, the proportion of the contained ethylene oxide unit is preferably less than 60 mass %.

Next, see TABLE 7.

As clearly seen from TABLE 7, sample films which do not contain a 2-(2-vinyloxy ethoxy) ethyl acrylate monomer unit and sample films in which the proportion of the contained 2-(2-vinyloxy ethoxy) ethyl acrylate monomer unit is less than 15 mass % have poor PC adhesion. On the other hand, sample films in which the proportion of the contained 2-(2-vinyloxy ethoxy) ethyl acrylate monomer unit is not less than 45 mass % have excellent PC adhesion but poor microbicidal ability. In the sample film of Comparative Example 8, the proportion of the contained 2-(2-vinyloxy ethoxy) ethyl acrylate monomer unit is not less than 15 mass % and less than 45 mass %, but the proportion of the contained ethylene oxide unit is less than 35 mass %, and therefore, the microbicidal ability is poor.

In order to sterilize water by bringing the water into contact with the surface of the synthetic polymer film, it is probably preferred that the surface of the synthetic polymer film is hydrophilic. That is, the probability that polymer chains at the surface of the synthetic polymer film will interact with bacteria included in the water increases and, as a result, the microbicidal ability improves. It is estimated that the ethylene oxide unit contributes to the microbicidal ability by making the surface of the synthetic polymer film hydrophilic.

The 2-(2-vinyloxy ethoxy)ethyl acrylate monomer is not water-soluble and therefore decreases the hydrophilicity of the synthetic polymer film as the proportion of the 2-(2-vinyloxy ethoxy) ethyl acrylate monomer unit contained in the synthetic polymer film increases. As a result, the microbicidal ability deteriorates. Note that a water-soluble monomer refers to such a monomer that the amount of water (about 20° C.) required for dissolving 1 g or 1 ml of the monomer is less than 100 ml. Since the 2-(2-vinyloxy ethoxy)ethyl acrylate monomer is a bifunctional monomer whose molecular weight is relatively small, it is probable that the microbicidal ability deteriorates as the crosslink density increases as disclosed in International Application No. PCT/JP2018/030788.

As described with the experimental examples, excellent PC adhesion and excellent microbicidal ability can be achieved so long as the proportion of the ethylene oxide unit contained in the crosslink structure of the synthetic polymer film to the entirety of the synthetic polymer film is not less than 35 mass % and less than 70 mass % and the proportion of the 2-(2-vinyloxy ethoxy) ethyl acrylate monomer unit contained in the crosslink structure of the synthetic polymer film to the entirety of the synthetic polymer film is not less than 15 mass % and less than 45 mass %.

The same effects can also be achieved when a 2-(2-vinyloxy ethoxy) ethyl methacrylate monomer (e.g., VEEM manufactured by NIPPON SHOKUBAI CO., LTD.) is used instead of the 2-(2-vinyloxy ethoxy)ethyl acrylate monomer. Instead of mass % of VEEA in respective ones of the above-described compositions, a value obtained by multiplying mass % of VEEA by 200/184 is used for recalculation such that all the constituents constitute 1.00%. For example, when VEEA of Example 12 is replaced by VEEM, the proportion of the contained VEEM is 45.5 mass %. Thus, it is estimated that also when the 2-(2-vinyloxy ethoxy) ethyl methacrylate monomer is used, the same effects are achieved in the above-described composition range. The 2-(2-vinyloxy ethoxy)ethyl acrylate monomer and the 2-(2-vinyloxy ethoxy) ethyl methacrylate monomer are generically referred to as “2-(2-vinyloxy ethoxy)ethyl (meth)acrylate monomer”.

In the above-described example, the plastic base is a polycarbonate film, and the plastic product is a layered film which includes a polycarbonate film and a synthetic polymer film. However, the present invention is not limited to this example. For example, a plastic molded product of polycarbonate can be used as the plastic base. In this case, a moth-eye mold may be used which is manufactured using an aluminum film deposited on a glass base of a desired shape.

By laminating a molded product of various shapes with a layered film which includes a polycarbonate film and a synthetic polymer film, the microbicidal ability can be given to the surface of the molded product of various shapes.

A plastic product according to an embodiment of the present invention is suitably applicable to uses which require sterilization of water within a short time period.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2017-176590 filed on Sep. 14, 2017, the entire contents of which are hereby incorporated by reference.

What is claimed is:

1. A plastic product, comprising a plastic base which has a surface and a synthetic polymer film provided on the surface of the plastic base, the surface of the plastic base being made of polycarbonate,
wherein the synthetic polymer film has a plurality of first raised portions whose two-dimensional size is in a range of more than 20 nm and less than 500 nm when viewed in a normal direction of the synthetic polymer film,
the synthetic polymer film has a crosslink structure, the crosslink structure containing an ethylene oxide unit and a 2-(2-vinyloxy ethoxy)ethyl (meth)acrylate monomer unit, and
a proportion of the contained ethylene oxide unit to an entirety of the synthetic polymer film is not less than 35 mass % and less than 70 mass %, and a proportion of the contained 2-(2-vinyloxy ethoxy)ethyl (meth)acrylate monomer unit to the entirety of the synthetic polymer film is not less than 15 mass % and less than 45 mass %.

2. The plastic product of claim 1, wherein the proportion of the contained 2-(2-vinyloxy ethoxy)ethyl (meth)acrylate monomer unit is less than 40 mass %.

3. The plastic product of claim 1, wherein the proportion of the contained ethylene oxide unit is less than 60 mass %.

4. The plastic product of claim 1, wherein the proportion of the contained ethylene oxide unit is more than 40 mass %.

5. The plastic product of claim 1, wherein the crosslink structure does not contain a nitrogen element which is a constituent of a urethane bond or a fluorine element.

6. The plastic product of claim 1, wherein the plastic base includes a polycarbonate film.

7. The plastic product of claim 6, wherein the plastic product is a layered film which includes the polycarbonate film and the synthetic polymer film.
